(19) United States
(12) Patent Application Publication
(10) Pub. No.: US 2023/0380501 A1
(43) Pub. Date: Nov. 30, 2023

(54) VAPORIZER AND ELECTRONIC VAPORIZATION DEVICE

(71) Applicant: SHENZHEN SMOORE TECHNOLOGY LIMITED, Shenzhen (CN)

(72) Inventors: Hongming ZHOU, Shenzhen (CN); Huanxi LI, Shenzhen (CN); Rihong LI, Shenzhen (CN); Xianwu DU, Shenzhen (CN); Wenli DU, Shenzhen (CN)

(21) Appl. No.: 18/448,157

(22) Filed: Aug. 10, 2023

Related U.S. Application Data
(63) Continuation of application No. PCT/CN2022/075865, filed on Feb. 10, 2022.

(30) Foreign Application Priority Data
Feb. 26, 2021 (CN) 202120425553.7

(51) Int. Cl. A24F 40/46; A24F 40/10; A24F 40/485; A24F 40/42; A24F 40/44; H05B 3/20; H05B 3/40

(52) U.S. Cl. CPC A24F 40/46; A24F 40/10; A24F 40/485; A24F 40/42; H05B 2203/032; H05B 3/20; H05B 3/40; H05B 2203/021; A24F 40/44

(57) ABSTRACT

A vaporizer includes: an infrared radiator for radiating heat; and a vaporization core including an accommodating cavity for accommodating the infrared radiator, the vaporization core having a vaporization surface defining a boundary of the accommodating cavity. An entirety of the vaporization surface is arranged around the infrared radiator. A gap is formed between the vaporization surface and the infrared radiator.

### CROSS-REFERENCE TO PRIOR APPLICATION

This application is a continuation of International Patent Application No. PCT/CN2022/075865, filed on Feb. 10, 2022, which claims priority to Chinese Patent Application No. 202120425553.7, filed on Feb. 26, 2021. The entire disclosure of both applications is hereby incorporated by reference herein.

### FIELD

This application relates to the field of electronic vaporization technologies, and in particular, to a vaporizer and an electronic vaporization device including the vaporizer.

### BACKGROUND

An electronic vaporization device generally includes a power supply assembly and a vaporizer. The power supply assembly supplies power to a vaporizer, and the vaporizer converts the electric energy into thermal energy. A liquid in the vaporizer absorbs the thermal energy and is vaporized to form aerosols inhalable by a user. However, for traditional vaporizers, a liquid vaporization amount per unit time is usually small, resulting in a small concentration of generated aerosols. In addition, the liquid is burnt as a result of the heating temperature being much higher than the vaporization temperature, resulting in a burnt taste in the aerosols, which affects the inhalation experience of a user.

### SUMMARY

In an embodiment, the present invention provides a vaporizer, comprising: an infrared radiator configured to radiate heat; and a vaporization core comprising an accommodating cavity configured to accommodate the infrared radiator, the vaporization core having a vaporization surface defining a boundary of the accommodating cavity, wherein an entirety of the vaporization surface is arranged around the infrared radiator, and wherein a gap is formed between the vaporization surface and the infrared radiator.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a longitudinal schematic structural cross-sectional view of a vaporizer according to an embodiment of this application.

FIG. 2 is a schematic structural exploded view of the vaporizer shown in FIG. 1.

FIG. 3 is a transverse schematic structural cross-sectional view of a first example of the vaporizer according to an embodiment of this application.

FIG. 4 is a transverse schematic structural cross-sectional view of a second example of the vaporizer according to an embodiment of this application.

### DETAILED DESCRIPTION

In an embodiment, the present invention describes how to increase the concentration of aerosols and eliminate the burnt taste.

An aspect of this application provides a vaporizer, including:
an infrared radiator, where the infrared radiator is configured to radiate heat; and
a vaporization core, where an accommodating cavity configured to accommodate the infrared radiator is arranged on the vaporization core, the vaporization core has a vaporization surface for defining a boundary of the accommodating cavity, the entire vaporization surface is arranged around the infrared radiator, and a gap is formed between the vaporization surface and the infrared radiator.

In an embodiment, the cross-sectional size of the gap is constant and is in a range of 0.5 mm to 3.0 mm.

In an embodiment, the infrared radiator includes a spiral structure formed by winding a line, the cross-sectional size of the line is in a range of 0.1 mm to 0.4 mm, and the spiral diameter of the spiral structure is in a range of 3 mm to 6 mm, or the infrared radiator includes a columnar structure with the cross-sectional size in a range of 1 mm to 2 mm, or the infrared radiator includes a sheet structure with the thickness in a range of 0.2 mm to 0.35 mm and the width in a range of 2 mm to 5 mm.

In an embodiment, the infrared radiator includes a first end and a second end arranged opposite to each other, both of which are fixed ends.

In an embodiment, a central axis of the accommodating cavity is a straight line.

In an embodiment, an air inlet channel and an inhalation channel both in communication with the outside are arranged on the vaporizer, the accommodating cavity is in communication between the air inlet channel and the inhalation channel, and the central axes of the air inlet channel, the inhalation channel, and the accommodating cavity are straight lines coinciding with each other.

In an embodiment, operating stages of the infrared radiator include a start-up stage and a vaporization stage following the start-up stage, the start-up temperature of the infrared radiator in the start-up stage is greater than the vaporization temperature in the vaporization stage, the start-up temperature is in a range of 350° C. to 700° C., and the vaporization temperature is in a range of 300° C. to 350° C.

In an embodiment, the duration of the start-up phase is in a range of 0.1 s to 0.2 s.

In an embodiment, the vaporizer further includes a shell assembly, a liquid inlet member, and a liquid guide member, the liquid inlet member is connected to the shell assembly, a liquid storage cavity is formed between the liquid inlet member and the shell assembly, the liquid guide member is pressed between the liquid inlet member and the vaporization core, and a liquid inlet hole in communication with the liquid storage cavity and configured to transmit a to-be-vaporized medium to the liquid guide member is arranged on the liquid inlet member.

Another aspect of this application provides an electronic vaporization device, including a power supply assembly and the vaporizer described in any of the above. The vaporizer is connected to the power supply assembly.

Details of one or more embodiments of this application are provided in the following drawings and description. Other features, objectives, and advantages of this application become apparent from the description, the drawings, and the claims.

To help understand this application, the following describes this application more comprehensively with reference to the related drawings. The drawings show exemplary implementations of this application. However, this application may be implemented in many different forms, and is not limited to the implementations described herein. On the contrary, the implementations are provided to make understanding of the disclosed content of this application more comprehensive.

It should be noted that, when an element is referred to as “being fixed to” another element, the element may be directly located on the another element, or an intermediate element may exist. When an element is considered to be “connected to” another element, the element may be directly connected to the another element, or an intermediate element may exist. The terms “inside”, “outside”, “left”, “right”, and similar expressions used herein are used for illustration and do not indicate a unique implementation.

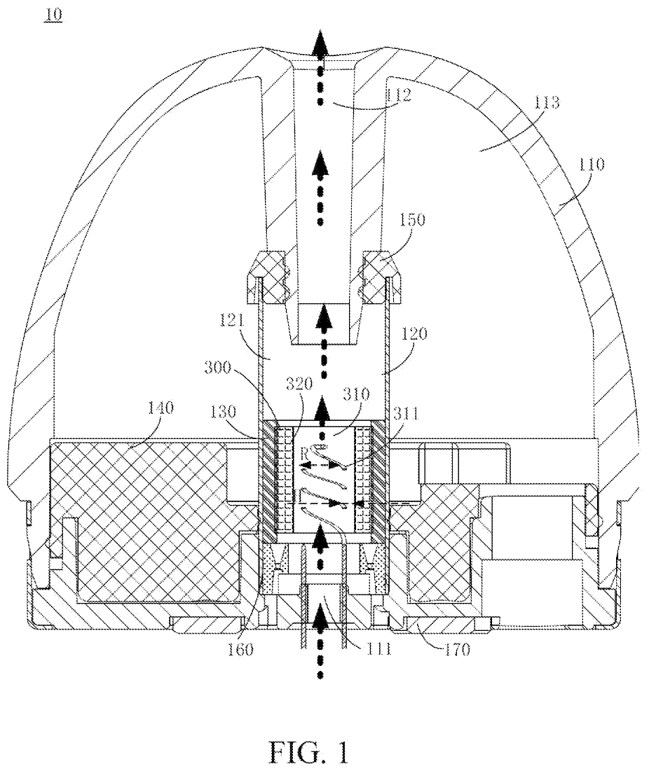

Referring to FIG. 1 to FIG. 4, a vaporizer 10 provided in an embodiment of this application includes a shell assembly 110, a liquid inlet member 120, a liquid guide member 130, a sealant plug 140, an upper seal ring 150, a lower seal ring 160, a contact electrode 170, an infrared radiator 200, and a vaporization core 300. The shell assembly 110 is configured to accommodate the liquid inlet member 120, the liquid guide member 130, the sealant plug 140, the upper seal ring 150, the lower seal ring 160, the contact electrode 170, the infrared radiator 200, and the vaporization core 300.

An inhalation channel 112 in communication with the outside is arranged on an upper portion of the shell assembly 110, and an air inlet channel 111 in communication with the outside is arranged on a lower portion of the shell assembly 110. The liquid inlet member 120 may be a tubular structure, and an upper end of the liquid inlet member 120 is fixed to the shell assembly 110, so that a tube cavity 121 of the liquid inlet member 120 is in communication with the inhalation channel 112. The upper seal ring 150 is pressed between the liquid inlet member 120 and the shell assembly 110. A liquid storage cavity 113 is formed among the shell assembly 110, the liquid inlet member 120, and the sealant plug 140. The liquid storage cavity 113 is configured to store a to-be-vaporized liquid medium, which may be an aerosol-forming substrate such as oil liquid. The upper seal ring 150 may provide sealing, to prevent communication between the liquid storage cavity 113 and the inhalation channel 112 and the tube cavity 121 of the liquid inlet member 120, thereby preventing the to-be-vaporized liquid medium in the liquid storage cavity 113 from flowing into the inhalation channel 112 and the tube cavity 121 of the liquid inlet member 120. A lower end of the liquid inlet member 120 is also fixed to the shell assembly 110, and the lower seal ring 160 is pressed between the lower end of the liquid inlet member 120 and the shell assembly 110. The lower seal ring 160 provides sealing for the tube cavity 121 of the liquid inlet member 120, so that the lower end of the tube cavity 121 of the liquid inlet member 120 is hermetically communicated with the air inlet channel 111.

The liquid guide member 130 may be made of a cotton material, and the liquid guide member 130 may be a tubular structure. The liquid guide member 130 is sleeved in the liquid inlet member 120, that is, the tube cavity 121 of the liquid inlet member 120 accommodates the liquid guide member 130. A liquid inlet hole 122 is arranged at a position on the liquid inlet member 120 corresponding to the liquid guide member 130. The liquid inlet hole 122 is in communication with the liquid storage cavity 113, so that the to-be-vaporized medium in the liquid storage cavity 113 may flow into the liquid guide member 130 through the liquid inlet hole 122. Since the liquid guide member 130 is made of the cotton material, the liquid guide member 130 may transmit and buffer the to-be-vaporized medium flowing out through the liquid inlet hole 122.

The vaporization core 300 may be made of a porous ceramic material, so that vaporization core 300 includes a large amount of micropores therein to form a specific porosity. By virtue of the micropores, the vaporization core 300 can transmit and buffer the to-be-vaporized medium. The vaporization core 300 may be a tubular structure, and the vaporization core 300 is sleeved in the liquid guide member 130. An accommodating cavity 310 is arranged on the vaporization core 300. The cross-section of the accommodating cavity 310 may be circular, elliptical, rectangular, regular polygonal structures, or the like. The vaporization core 300 has a vaporization surface 320. The vaporization surface 320 is configured to define a boundary of the accommodating cavity 310. Generally speaking, the vaporization surface 320 is an inner wall surface of the accommodating cavity 310. The air inlet channel 111 is communicated with the accommodating cavity 310 through the lower end of the tube cavity 121 of the liquid inlet member 120, and the inhalation channel 112 is communicated with the accommodating cavity 310 through the upper end of the tube cavity 121 of the liquid inlet member 120. When the liquid in the liquid storage cavity 113 enters the liquid guide member 130 through the liquid inlet hole 122 of the liquid inlet member 120, the vaporization core 300 absorbs the to-be-vaporized medium in the liquid guide member 130, and the to-be-vaporized medium permeates the vaporization core 300 from the liquid guide member 130 and reaches the vaporization surface 320.

The infrared radiator 200 may be made of metal, heating ceramics, or conductive infrared materials. The contact electrode 170 extends thorough the lower portion of the shell assembly 110. The contact electrode 170 is electrically connected to the infrared radiator 200, so that the contact electrode 170 may transmit a current to the infrared radiator 200. The infrared radiator 200 is connected to the shell assembly 110 and spaced apart from the vaporization surface 320, which effectively prevents the infrared radiator 200 from directly adhering to the vaporization surface 320. A gap 311 exists between the vaporization surface 320 and the infrared radiator 200. It may be understood that the gap 311 is actually a part of the accommodating cavity 310. When the contact electrode 170 transmits the current to the infrared radiator 200, the infrared radiator 200 generates heat and radiates the heat to the vaporization surface 320 through infrared radiation. When the to-be-vaporized medium on the vaporization surface 320 absorbs the heat and rises to the vaporization temperature, the to-be-vaporized medium is vaporized into aerosols.

When a user inhales at the end of the inhalation channel 112, the external air enters the gap 311 from the air inlet channel 111 through the lower end of the tube cavity 121 of the liquid inlet member 120, so that the external air carries the aerosol in the gap 311 into the inhalation channel 112 through the upper end of the tube cavity 121 of the liquid inlet member 120, and the aerosol entering the inhalation channel 112 is inhaled by the user. The dashed-line arrows in FIG. 1 indicate a gas flow trajectory.

For example, the vaporizer adopts a design mode of directly attaching a heating resistance wire to the vaporization surface. In the design mode, the heating resistance wire is electrified to generate heat, the heat is passed to the vaporization surface through thermal conduction, and the to-be-vaporized medium on the vaporization surface absorbs the heat of the heating resistance wire and is vaporized into aerosols. However, the design mode has at least the following disadvantages:
The first disadvantage is as follows: Since the heat is transmitted through thermal conduction, opportunities for regions on the vaporization surface to absorb the heat are unequal, and therefore, the distribution of the heat on the vaporization surface is non-uniform. For example, the region on the vaporization surface near the heating resistance wire absorbs more heat, and thus forms a high-temperature region with a higher temperature. The to-be-vaporized medium located in the high-temperature region is burnt due to the excessively high temperature, which results in a burnt taste to the aerosols, thus affecting the inhalation taste of the user. In addition, the region away from the heating resistance wire absorbs less heat, and thus forms a low-temperature region with a lower temperature. The to-be-vaporized medium located in the low-temperature region cannot be fully vaporized due to the low temperature, which results in large vaporized particles, thus affecting the inhalation taste. Certainly, the temperature in the low-temperature region even cannot reach the vaporization temperature, and therefore cannot vaporize the to-be-vaporized medium, which results in a decrease in the vaporization amount of the to-be-vaporized medium per unit time and a low concentration of the aerosols.
The second disadvantage is as follows: Since the heating resistance wire is usually made of heavy metal materials, during the operation of the heating resistance wire, the heating resistance wire undergoes a series of physical and chemical reactions with the to-be-vaporized medium attached to the heating resistance wire at the high temperature, which causes the heavy metal elements to enter the aerosols and be absorbed by the user. In this case, damage is caused to the physical health of the user and a safety risk is caused to the entire vaporizer. In addition, the to-be-vaporized medium attached to the heating resistance wire absorbs the heat during the vaporization, which leads to a decrease in the temperature of the heating resistance wire. As a result, the temperature of the heating resistance wire fluctuates during the operation, which affects the inhalation taste of the aerosols.
The third disadvantage is as follows: There are two aerosol generation sources. One source is the region on the vaporization surface where no heating resistance wire is arranged. The region is denoted as a vaporization region of the vaporization surface. The vaporization region has a large amount of supplied to-be-vaporized media and forms a large amount of aerosols. The other source is the surface region of the heating resistance wire. Since the heating resistance wire is generally made of dense metal or alloy materials, the permeation and transmission capabilities of the heating resistance wire for the to-be-vaporized medium are lower than those of the vaporization core. Therefore, the surface region has a small amount of supplied to-be-vaporized media and forms a small amount of aerosols. In fact, the aerosols generated by the to-be-vaporized medium on the surface region of the heating resistance wire are negligible compared to the aerosols generated by the to-be-vaporized medium on the vaporization region of the vaporization surface. Since the heating resistance wire occupies a considerable part of the vaporization surface, the effective area of the vaporization region is less than the total area of the vaporization surface, resulting in a difficulty in increasing the vaporization amount of the to-be-vaporized medium per unit time and thus affecting the concentration of aerosols.
The fourth disadvantage is as follows: Since a part of the heat of the heating resistance wire is transmitted to a region outside the vaporization surface, the utilization of the heat of the heating resistance wire is reduced, which affects the vaporization amount of the to-be-vaporized medium per unit time and the concentration of aerosols.

According to the vaporizer 10 of the above embodiment, since the vaporization surface 320 is arranged around the infrared radiator 200, and the gap 311 exists between the infrared radiator 200 and the vaporization surface 320, the infrared radiator 200 is effectively prevented from directly adhering to the vaporization surface 320. In this way, at least the following beneficial effects can be realized:
First, since the spacing arrangement of the infrared radiator 200 and the vaporization surface 320 does not occupy a part of the vaporization surface 320, the total area of the vaporization surface 320 is the effective area of the vaporization region, which greatly increases the effective area of the vaporization region, thereby improving the vaporization amount of the to-be-vaporized medium per unit time and the concentration of aerosols, and thus improving the user experience. In addition, the vaporization surface 320 has a curved structure. Compared with a vaporization surface 320 with the same area in a flattened state, the vaporization surface 320 is actually in a coiled state, which greatly reduces the mounting space occupied for the vaporization surface 320, thereby realizing a more compact structure of the vaporizer 10.
Secondly, the infrared radiator 200 is prevented from direct contact with the to-be-vaporized medium on the vaporization surface 320, which prevents physical and chemical reactions between the infrared radiator 200 and the to-be-vaporized medium at the high temperature, thereby preventing heavy metal elements in the infrared radiator 200 from entering the aerosol and being absorbed by the user, and thus improving the use safety of the vaporizer 10. In addition, since the to-be-vaporized medium is spaced apart from the infrared radiator 200, the to-be-vaporized medium is prevented from absorbing the heat during the vaporization and thus reducing the temperature of the infrared radiator 200, which avoids temperature fluctuations of the infrared radiator 200, thereby ensuring a consistent temperature of the infrared radiator 200 and improving the inhalation taste of the aerosol.
Thirdly, the heat on the infrared radiator 200 is transmitted to the vaporization surface 320 through infrared radiation. Compared with the way of heat conduction, the opportunities for the regions on the vaporization surface 320 to absorb the heat are more equal, which ensures uniform distribution of the heat on the vaporization surface 320, so that the temperatures are consistent on the vaporization surface 320, thereby preventing local high and low temperatures on the vaporization surface 320, and thus avoiding a burnt taste and large particles that affects the inhalation taste.
Fourthly, since the entire vaporization surface 320 is arranged around the infrared radiator, most of the heat generated by the infrared radiator 200 is absorbed by the vaporization surface 320, which prevents impact on the energy utilization as a result of heat radiating into the space outside the vaporization surface 320, thereby improving the vaporization amount of the to-be-vaporized medium per unit time and the concentration of aerosols. In addition, since the infrared radiator 200 is surrounded by the vaporization core 300, an insulator or a reflector corresponding to the infrared radiator 200 may be omitted, thereby simplifying the structure of the vaporizer 10.

In some embodiments, the cross-sectional size of the gap 311 between the infrared radiator 200 and the vaporization surface 320 is constant, which can further improve the almost equal absorption of heat by the vaporization surface 320, improve the uniformity of distribution of the heat on the vaporization surface 320, and prevent local high temperatures on the vaporization surface 320. The cross-sectional size H of the gap 311 may be in a range of 0.5 mm to 3.0 mm. The specific value may be 0.5 mm, 2.5 mm, 3 mm, or the like.

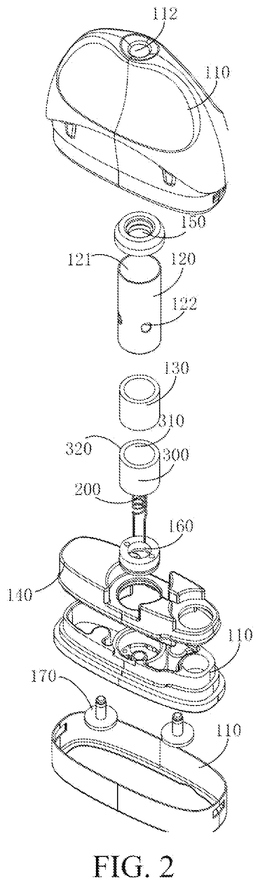

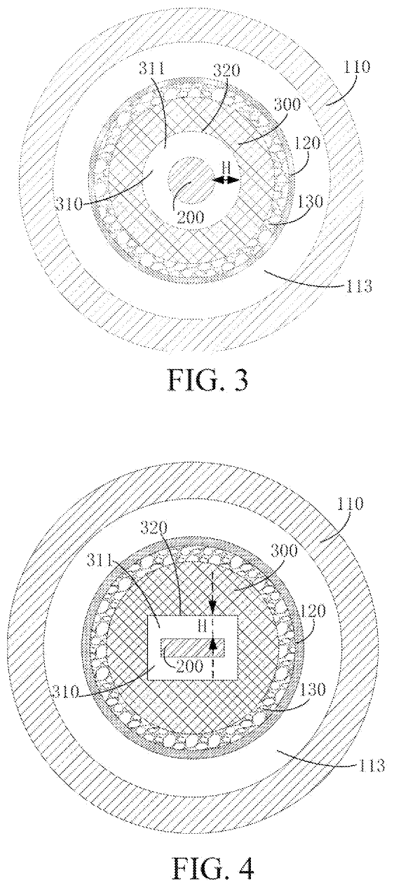

In some embodiments, for example, as shown in FIG. 1 and FIG. 2, the infrared radiator 200 includes a spiral structure formed by winding a line, the cross-sectional size of the line is in a range of 0.1 mm to 0.4 mm, and the spiral diameter of the spiral structure is in a range of 3 mm to 6 mm. For another example, as shown in FIG. 3, the infrared radiator 200 includes a columnar structure. The cross-sectional size of the columnar structure is in a range of 1 mm to 2 mm. The columnar structure may be cylindrical or prismatic. For another example, as shown in FIG. 4, the infrared radiator 200 includes a sheet structure. The thickness of the sheet structure is in a range of 0.2 mm to 0.35 mm, and the width is in a range of 2 mm to 5 mm.

In some embodiments, the infrared radiator 200 includes a first end and a second end arranged opposite to each other, both of which are fixed ends. Generally speaking, the both ends of the infrared radiator 200 are fixed to avoid free cantilever ends of the infrared radiator 200. This improves the stiffness and stability of the infrared radiator 200, avoid a change in the gap 311 caused by the shaking of the infrared radiator 200, and ensure uniform and consistent heat distribution in the regions on the vaporization surface 320. Certainly, the infrared radiator 200 may be sintered with the vaporization core 300 as a whole module, which can facilitate assembly and ensure the uniformity of the gap 311.

In some embodiments, the central axes of the accommodating cavity 310, the tube cavity 121 of the liquid inlet member 120, the air inlet channel 111, and the inhalation channel 112 are straight lines coinciding with each other. Therefore, during the inhalation of the user, the flow trajectory of the external air carrying the aerosol is almost straight, which prevents the aerosol from generating vortices as a result of the bending of the flow trajectory, reduces the chances of collision between small particles, and reduces the proportion of large particles formed by collision of small particles in the aerosol, thereby avoiding the impact of the large particles on the inhalation taste, and improving the inhalation experience for the user.

In some embodiments, operating stages of the infrared radiator 200 include a start-up stage and a vaporization stage following the start-up stage. The start-up temperature of the infrared radiator 200 in the start-up stage is greater than the vaporization temperature in the vaporization stage. For example, the start-up temperature is in a range of 350° C. to 700° C., and the vaporization temperature is in a range of 300° C. to 350° C. The duration of the start-up phase is in a range of 0.1 s to 0.2 s. Since the infrared radiator 200 is spaced apart from the to-be-vaporized medium, setting a relatively high start-up temperature can effectively shorten the time required for the to-be-vaporized medium to rise to the vaporization temperature, thereby improving the vaporization speed of the to-be-vaporized medium and the sensitivity of the vaporizer 10 in response to inhalation.

This application further provides an electronic vaporization device. The electronic vaporization device includes a power supply assembly and the vaporizer 10. A battery of the power supply assembly supplies power to the infrared radiator 200. The vaporizer 10 may be detachably connected to the power supply assembly. After the to-be-vaporized medium in the vaporizer 10 is consumed, the vaporizer 10 may be disassembled from the power supply assembly and discarded, and then a new vaporizer 10 filled with the to-be-vaporized medium may be mounted to the power supply assembly. Therefore, the power supply assembly may be cyclically used, and the vaporizer 10 is a disposable consumable. In other embodiments, the to-be-vaporized medium may be injected into the liquid storage cavity 113 to cyclically use the vaporizer 10. Certainly, the vaporizer 10 may alternatively be non-detachably connected to the power supply assembly.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in the description.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporizer, comprising:
an infrared radiator configured to radiate heat; and
a vaporization core comprising an accommodating cavity configured to accommodate the infrared radiator, the vaporization core having a vaporization surface defining a boundary of the accommodating cavity,
wherein an entirety of the vaporization surface is arranged around the infrared radiator, and
wherein a gap is formed between the vaporization surface and the infrared radiator.

2. The vaporizer of claim 1, wherein a cross-sectional size of the gap is constant and is in a range of 0.5 mm to 3.0 mm.

3. The vaporizer of claim 1, wherein the infrared radiator comprises a spiral structure formed by winding a line, a cross-sectional size of the line is in a range of 0.1 mm to 0.4 mm, and a spiral diameter of the spiral structure is in a range of 3 mm to 6 mm, or
wherein the infrared radiator comprises a columnar structure with a cross-sectional size in a range of 1 mm to 2 mm, or
wherein the infrared radiator comprises a sheet structure with a thickness in a range of 0.2 mm to 0.35 mm and a width in a range of 2 mm to 5 mm.

4. The vaporizer of claim 1, wherein the infrared radiator comprises a first end and a second end arranged opposite each other, both the first end and the second end being fixed ends.

5. The vaporizer of claim 1, wherein a central axis of the accommodating cavity is a straight line.

6. The vaporizer of claim 5, wherein an air inlet channel and an inhalation channel, both in communication with an outside, are arranged on the vaporizer,
wherein the accommodating cavity is in communication between the air inlet channel and the inhalation channel, and
wherein central axes of the air inlet channel, the inhalation channel, and the accommodating cavity are straight lines coinciding with each other.

7. The vaporizer of claim 1, wherein operating stages of the infrared radiator comprise a start-up stage and a vaporization stage following the start-up stage,
wherein a start-up temperature of the infrared radiator in the start-up stage is greater than a vaporization temperature in the vaporization stage,
wherein the start-up temperature is in a range of 350° C. to 700° C., and
wherein the vaporization temperature is in a range of 300° C. to 350° C.

8. The vaporizer of claim 7, wherein a duration of the start-up phase is in a range of 0.1 s to 0.2 s.

9. The vaporizer of claim 1, further comprising:
a shell assembly;
a liquid inlet member; and
a liquid guide member,
wherein the liquid inlet member is connected to the shell assembly,
wherein a liquid storage cavity is formed between the liquid inlet member and the shell assembly,
wherein the liquid guide member is pressed between the liquid inlet member and the vaporization core, and
wherein a liquid inlet hole in communication with the liquid storage cavity and configured to transmit a to-be-vaporized medium to the liquid guide member is arranged on the liquid inlet member.

10. An electronic vaporization device, comprising:
a power supply assembly; and
the vaporizer of claim 1,
wherein the vaporizer is connected to the power supply assembly.
